(19) United States
(12) Patent Application Publication
(10) Pub. No.: US 2022/0362834 A1
(43) Pub. Date: Nov. 17, 2022

(54) METHOD FOR PRODUCING A SCREW ELEMENT BLANK AND A SCREW ELEMENT, AND SCREW ELEMENT BLANK AND SCREW ELEMENT

(71) Applicant: SF HANDELS- UND BESITZGESELLSCHAFT MBH, Aldingen (DE)

(72) Inventor: Hartmut Flaig, Aldingen (DE)

(73) Assignee: SF HANDELS- UND BESITZGESELLSCHAFT MBH, Aldingen (DE)

(21) Appl. No.: 17/620,166

(22) PCT Filed: Apr. 20, 2020
(86) PCT No.: PCT/EP2020/061011

§ 371 Date: Dec. 17, 2021

(30) Foreign Application Priority Data
Jun. 17, 2019 (DE) 10 2019 116 338.2

(51) Int. Cl. B21K 1/46

(52) U.S. Cl. CPC B21K 1/463

(57) ABSTRACT

The invention relates to a method for producing a gland or a gland blank (3), the method comprising a step of producing a blank (3) having a cylindrical shaft (5) formed on a screw head (4), and a blind hole (7) being formed in the blank (3) from an upper side (11) of the screw head (4) facing away from the shaft (5) in a, in particular further, method step, the blind hole (7) extending toward the shaft (5) and forming at least one first section (13), in particular having a polygonal cross section (Q1), preferably for receiving a screw tool. The blind hole (7) is deepened, thus forming at least one second section (14), which borders the first section (13), in a subsequent method step, the second section (14) forming a preferably at least partially continuous cross section (Q2) which is in particular smaller in size than the first cross section (Q1), the shaft (5) being widened in sections, thus forming an undercut (15) at the crossover between the shaft (5) and the screw head (4), in particular by at least indirectly displacing material from at least the second section (14) of the blind hole (7), in the subsequent method step.

### BACKGROUND OF THE INVENTION

The invention relates to a method for producing a screw element blank and for producing a screw element. Furthermore, the invention at hand relates to a screw element blank and to screw elements all as disclosed herein.

In joining and sealing technology, screws and nuts among other elements are used to connect components to each other and to seal openings. In the present instance, an inventive concept is described which can be used for screws, in particular sealing screws or glands, and for nuts, in particular fastening nuts with/for defined friction values.

Concerning the screws as screw elements, different glands and sealing screws along with their precursors, in particular blanks or semi-finished products, are known from the state of the art. The known glands and sealing screws are preferably, though by no means exclusively, used as oil drain screws, which are used for sealing an inner thread opening in a receiving body, in particular for sealing a fluid line or for sealing a fluid vessel, preferably in an oil line or in an oil vessel, the oil line or the oil vessel preferably being allocated to a gear unit or a gearbox casing of a combustion engine. The sealing screws or glands are provided with an outer thread, in particular provided with a cylindrical shaft having an outer thread thereon, with which an inner thread of an inner thread opening of the receiving body mentioned above is screwed together.

The known sealing screws or glands, which will be referred to as glands in the following, have proven to be particularly advantageous with regard to imperviousness between the gland and the receiving body if the gland has an undercut or a turned-down portion at the crossover between the shaft having the outer thread and a head bordering the shaft, the undercut or turned-down portion realizing or enabling particularly advantageously that the head or screw head, in particular a sealing surface of the screw head facing the shaft, abuts against a corresponding counter-surface of the receiving opening or of the receiving body in a sealing manner.

In order to produce the corresponding undercut or turned-down portion at the crossover between the shaft and the head or screw head, different production techniques have stood the test of time. On the one hand, it is possible to produce the undercut or turned-down portion in the scope of machining a blank, for example before a thread is introduced, in particular cut, into the cylindrical shaft. This procedure allows producing the undercut in the blank or in the screw relatively safely and independently of the overall shape or geometry of the gland to be produced; however, as mentioned above, a machining step is required, which involves material loss and moreover requires clamping and turning the screw or the screw blank an additional time, making the process more complex. On the other hand, however, machining the gland blank or the gland for producing the undercut leaves the utmost freedom regarding the overall design and shape of the gland.

Alternative techniques for producing a generic gland as a screw element and a corresponding blank are known from the field of cold extrusion. DE 20 2013 105 922 U1, DE 10 2006 046 631 A1 and WO2004/054739, for example, which have all been authored by the applicant, disclose glands and methods for producing gland blanks and glands, for which not only though in particular the undercut described above is produced at the crossover between the cylindrical shaft of the screw and the screw head by means of cold extrusion. The advantage of these methods for producing gland blanks and glands using cold extrusion lies on the one hand in the optimized or free-of-loss material usage and on the other hand in making additional method steps redundant, in particular method steps for clamping, turning and machining screws or screw blanks. The resulting glands and gland blanks are characterized in the same manner.

The state of the art, however, hitherto assumed a limitation of corresponding glands or gland blanks, the limitation extending to the production or realization of the undercut between the screw shaft and screw head and being linked to the basics of cold extrusion. Therefore, it had been hitherto assumed that, on the one hand, a one-sided removal of the screw or the screw blank, in particular in the axial direction, from a tool is absolutely required for producing a corresponding flank or tapering in the shaft of the screw or the screw blank for forming the turned-down portion in the corresponding cold extrusion step or continuous deformation step for completing the corresponding work step and, on the other hand, the outer circumference of the shaft, in particular the deformed outer surface forming the tapering or the undercut, must entirely abut against a tool which receives the screw or the screw blank and limits the deformation.

This in turn leads to the cylindrical shaft of the screw and the blank of the glands and gland blanks, as they have been mentioned above and which have been produced using methods for cold working, in particular cold extrusion, being widened in an end of the shaft facing away from the screw head, the widened portion tapering the closer it gets to the screw head and correspondingly forming the undercut, the widened portion being realized in each instance by forming a deepening or a blind hole on the end of the shaft of the end face facing away from the screw head owing to the limitations described above and the undercut being formed via the resulting material deformation. Thus, the widened portion and a corresponding abutment against a tool are caused radially adjacent to the deepening on the shaft, there being no contact to the tool in an undeformed or not widened area of the shaft.

Since the demand for glands having the undercut, which positively impacts the imperviousness, between the shaft end and the screw head while simultaneously having a flat surface, in particular a flat end face or even a protrusion extending away from the screw head, on the end of the screw shaft facing away from the screw head from an end face, has been steadily increasing, however, the production of such glands and their blanks was not possible by means of cold extrusion.

With regard to the screw elements realized as screw nut blanks and screw nuts and to the corresponding methods, the state of the art discloses nuts and screw elements, for example in DE102011 107 236A1, which enable fastening a component, for example a steering element, particularly preferably a wishbone of a motor vehicle, which is screwed into the screw opening of the nut, on a corresponding fastening element while taking up particularly little space. The screw elements in the form of screw nuts can also be produced by means of cold extrusion. The advantage of these methods for their production using cold extrusion also lies in the optimized or free-of-loss material usage and on the other hand in making additional method steps redundant, in particular method steps for clamping, turning and machining nuts or screw nuts. The resulting glands and gland blanks are characterized in the same manner.

The fundamental problem with nuts and screw elements of this kind are the unsatisfying adjustability or the insufficient predictability of the friction coefficients of the connection, in particular the friction coefficients between the screw element or the nut and the fastening element. In order to be able to better control the friction coefficients, different approaches have taken root, of which one envisions using a washer.

When using a washer, it is desirable for the washer to be fastened at the nut captively or so that it cannot be lost with regard to the connection between the nut, the screw element and the fastening element. To secure the washer relative to the nut or the screw element in this fashion, an undercut or a turned-down portion in a crossover area between a head or a nut head and a shaft or a nut shaft has also proven advantageous since the diameter of the shaft can be chosen such in this case that it is slightly larger than the inner diameter of the washer and the outer diameter of the undercut or the turned-down portion is slightly smaller than the inner diameter of the washer so that the washer is captively secured or disposed in the area of the undercut.

As is the case with screw elements mentioned above, preferably screws, in particular glands, the fact that it is preferable for methodical reasons for the end face of the shaft or the nut shaft facing away from a head or a nut head to be molded as little as possible or not at all, in particular before the screw opening has been produced, still causes a problem. This, however, causes the similarly concerning problem, as is the case with the screws or glands mentioned above, that the turned-down portion cannot be formed without difficulty or additional elaborate, in particular machining, work steps.

### SUMMARY OF THE INVENTION

Accordingly, the object of the present invention is to indicate screw elements and screw element blanks and methods for their production where the glands on the one hand comprise a flat surface or end face or a surface or end face equipped with a protrusion and facing away from the head while simultaneously comprising the undercut between the shaft and the head which improves the imperviousness or the securing effect and can be produced using means of cold working, in particular cold extrusion, preferably without machining work steps.

In a method for producing a screw element or a screw element blank comprising a method step in which a blank having a cylindrical shaft formed on a head is produced and a blind hole is formed in the blank from an upper side of the head facing away from the shaft in, in particular further, method steps, the blind hole extending toward the shaft and forming at least one first section, in particular having a polygonal cross section, preferably for receiving a screw tool or having a round cross section as a precursor of a screw opening, the object mentioned above is attained by the blind hole, which is already available on the head, being deepened, thus forming at least one second section, which borders the first section, in a subsequent method step, the second section forming a preferably at least partially continuous cross section which is in particular smaller in size than or identical to the first cross section, the shaft being widened in sections, thus forming an undercut at the crossover between the shaft and the head, in particular by at least indirectly displacing material from at least the second section of the blind hole, in the subsequent method step.

The idea of the invention at hand consequently is that particularly by overcoming the assumptions or prejudices described above regarding the limitations of cold extrusion, a widening in conjunction with the formation of a corresponding undercut between the at least partially widened shaft and the head is also made possible by the fact that a deformation, in particular a material displacement, from the rear, i.e., a deformation starting from the head, is carried out and that the screw element or the screw element blank can simultaneously still be removed from a tool, which correspondingly receives the blank, in particular in the axial direction of the blank, following the subsequent method step. In other words, this means that the invention at hand has deviated from the basic principles of cold working, in particular cold extrusion, with completely unforeseeable success, and a deformation in one direction or having an incline has been achieved by means of cold extrusion that would simply not have allowed a subsequent removal of the screw element or of the screw element blank from the tool receiving it according to the classic or hitherto valid conception of the limitations of cold extrusion. This particularly advantageously achieves that the widening does not have to take place by deformation in the area of an end side or end face of the cylindrical shaft facing away from the head on the one hand and thus the corresponding end side can be flat or can even comprise corresponding protrusions facing away from the screw head. Moreover, it is achieved that the screw element or the screw element blank further comprises the undercut at the crossover between the shaft and the head, which particularly has a positive impact on use. In addition, the screw elements or the screw element blanks can be produced by means of cold extrusion. In this case, it is particularly advantageously realized that an abutment and/or a support against a deforming tool is achieved in the widened section of the shaft so that the widening is limited and/or a defined surface of the shaft is produced in the widened area.

According to a particularly advantageous first embodiment of the method, it can be envisioned to widen the shaft in an area opposite the head. This particularly advantageously enables forming, in particularly rolling, a thread in the widened portion or in the area of the widened portion in this area, i.e., the area opposite the head, whereas the thread is not formed in the less widened or not widened area of the shaft, i.e., in an area of the shaft facing the head, and instead the undercut is formed for improving the imperviousness between the gland and the receiving body. At the same time, the inventive action and the inventive deviation from known or supposedly known limitations of cold extrusion are expressed in particular by the widened portion being formed in the area of the shaft facing away from the head or opposite the head. For when producing or widening a blind hole from the direction or on the head and correspondingly widening the shaft by at least indirectly displacing material from the introduced or produced blind hole, it would have to be assumed that easy removal from the tool receiving the blank or the screw element, i.e., a removal without splitting, disassembling or any other manner of taking apart the tool, in particular in the axial direction, would have been utterly impossible with a corresponding tool which enables or envisions but also limits widening the shaft, since the shaft has a larger diameter at its end facing away from the head than at the section bordering the head, and a flank or an incline correspondingly would have been produced and would have to be reproduced or indeed be predetermined by the corresponding tool, by means of which a removal of the screw element blank or of the screw element would not have been possible in particular by simply pulling or pressing out the screw element or the screw element blank in the axial direction of the middle symmetry axis since the head would not have allowed this kind of movement on one side and the widening of the shaft in conjunction with the corresponding flank of the deforming tool would have made pulling or pressing out the screw blank or the screw impossible on the other side. In this context, it should also be mentioned that the tool which receives the screw or the screw blank for executing the subsequent method step is realized as a one-piece tool at least in the circumferential direction so that radially opening two or more tool pieces, for example, is not possible or intended in order to ensure removing or the removal of the screw blank or the screw after the subsequent method step.

Accordingly, another variation of the method according to the invention can intend that a part of the widened section abuts against a radial deforming tool or tool part after the subsequent method step has been executed, while the part of the shaft forming the undercut has an increasingly larger distance in the axial direction of the head with respect to the radial deforming tool or the tool part. As described above, this embodiment deviates from hitherto existing principles of cold extrusion as the mentioned tool or tool part, which partially or at least in sections receives the shaft for the subsequent method step, most definitely does not entirely abut against the shaft or across the entire axial extension of the shaft or, vice versa, the shaft does not abut against the tool or the tool part, as was hitherto common for cold extrusion processes; instead the material indirectly displaced by forming and/or deepening the blind hole on the head leads to a maximum widening and thus to an abutment between the widened cylindrical shaft and the tool in an axial end area only, in particular in an axial end area of the shaft facing away from the head, while an increasingly larger distance between the tool or the tool part remains, in particular after the subsequent method step has been executed, as the distance from the end area of the shaft increases, in particular as the distance from the end area of the shaft opposite the head increases, so that the undercut is thereby formed between the shaft and the head. In other words, this means that it is possible, for example, to provide a tool or a tool part which is closed in the circumferential direction, is intended to receive the shaft and has or forms a flat inner surface or support surface which is specifically not inclined in the axial direction for the next step of the method, so that the non-abutment or the increasing distance between the tool and the blank in the axial direction ensures after the subsequent method step has been executed that the screw or the screw blank can be easily removed from, in particular pressed or pulled out of, the tool or the tool part without having to split or disassemble the tool or the tool part, despite part of the shaft section having being widened by producing a deepened part on the head in the form of the second section of the blind hole. At the same time, it is advantageous if no burr is formed in the area of different work tools, which would have to be removed afterward, when the tool shape is closed in the circumferential direction.

According to another particularly advantageous embodiment of the method, it can be intended to retain a flat end face of the shaft facing away from the head or an end face of the shaft equipped with a protrusion axially extending away from the end face in the scope of the subsequent method step.

In other words, this means that the method according to the invention can be used for realizing any other shape, in particular a flat shape or a shape of the end face of the shaft having a protrusion, instead of a deepened area or a recess to be introduced into the end side or the end face of the shaft for forming the widened portion. Thus, this allows advantageously reverting to the advantages of the production of glands and gland blanks in the scope of cold extrusion, while simultaneously the shape of the gland, in particular the shape of the end side or the end surface of shaft of the gland, can be chosen largely freely and the undercut, which positively impacts the imperviousness, can be formed in the crossover area between the shaft and the screw head at the same time.

According to another particularly preferred embodiment of the invention, in particular for producing a gland, it can be intended that an annular sealing surface is formed on an underside of the head facing the shaft for being abutted against an abutment surface of a receiving body, thus forming a coaxial annular groove, which is bordered radially outward by a circumferential annular wall. By forming a corresponding sealing surface, the impermeability properties of the gland are further positively impacted or increased. Preferably, it can be intended that the corresponding annular sealing surface is formed prior to the subsequent method step and is retained in the subsequent method step. Alternatively, however, it can be intended to form the sealing surface during the subsequent method step in conjunction with forming or deepening the blind hole.

According to another advantageous embodiment of the method, in particular in regard to a method for producing a nut or a screw nut, it can moreover be intended to dispose a washer in the area of the undercut, the washer being deformed in such a manner that the inner diameter is slightly larger than the outer diameter of the undercut after the deformation and moreover the inner diameter of the washer is smaller than the outer diameter of the widened section of the shaft. Through this, a method is attained which enables easily fastening the washer at the nut or screw nut and thus securing it captively or so that it cannot be lost. The washer itself enables precisely setting the friction coefficients between the nut and the fastening element for the nut or screw nut produced using the method.

Particularly advantageously, it can further be intended to produce a maximum widening of 2% to 9%, in particular of 5% to 7%, with respect to the shaft diameter, in particular with respect to a shaft diameter undeformed in the subsequent method step, in the subsequent method step. A corresponding widening 2% to 9%, in particular 5% to 7%, has proven advantageous since on the one hand, it allows introducing, in particular cutting, a thread in the area of the widened portion and simultaneously obtaining a correspondingly complete, properly formed undercut.

For excessive widening would run the risk of the correspondingly freestanding flank of the blank with respect to the tool, which can be envisioned within the scope of the method according to the invention, not or no longer being able to be formed properly and thus the undercut no longer or only insufficiently being able to be formed. To the same extent, a widening of 3% to 9%, in particular 5% to 7%, allows a sufficient tolerance for introducing the thread on the widened section of the shaft.

As for forming a screw element in the form of a nut or a screw nut, a slight widening of 2% to 4% can be advantageously intended, since this is sufficient to ensure the securing purpose for a washer. Forming or realizing an outer thread is not required for producing a nut.

Another particularly preferred embodiment of the method also intends that the blind hole is realized in such a manner that a bottom, in particular of the second section of the blind hole, extends up to 80%, preferably up to 75%, particularly preferably up to 70%, even more preferably up to 45%, of the overall height of the screw element starting from the upper side of the head. The overall height of the screw element is to extend between an end side or an end face of the shaft, in particular without taking any protrusions of the shaft into consideration, to an upper side of the head in this case. Forming the blind hole, in particular the second section of the blind hole, to a depth of up to 80% of the overall height particularly preferably allows on the one hand at least indirectly displacing material in a section of the shaft which reaches the end side or the end face of the shaft or extends thereto. This ensures that the widened portion becomes maximally widened directly before or shortly behind the end side or the end face, and thus a thread can be introduced in this area. Consequently, a sufficient section is provided for providing or introducing the thread of the gland in the axial direction.

As for a screw nut as a screw element, a penetration depth of the second section of 40% to 45% can already be sufficient since the widened portion has to be realized less prominently for securing the washer.

According to another particularly preferred embodiment of the method, it can be intended that the first section of the blind hole is realized in such a manner that a bottom of the first section of the blind hole extends up to 70%, preferably up to 65%, particularly preferably up to 40%, of the overall height of the screw element starting from the upper side of the head. The definition of the overall height of the screw element is once again to be based on the distance between an end side or end face of the shaft, which does not take the protrusions into account, on the one hand and the upper side of the head on the other hand. Forming the first section of the blind hole in such a manner on the one hand leads to a secure hold of a tool, as far as it is provided, in the first section of the blind hole being able to be ensured. On the other hand, this enables producing the screw element using comparatively little material. This in turn can advantageously reduce the production costs of the screw element and the costs for executing the method.

According to another advantageous embodiment of the method, which in particular focuses on the production of a nut or a screw nut, it can also be envisioned that the first section of the blind hole is produced in two or more partial steps; preferably, 70%, more preferably 80%, of the overall height of the blind hole, i.e., of the first section of the blind hole, is produced in a first partial step. This results in the forces and tensions which are produced in the material of the screw element or the screw element blank and the forces which act on the corresponding tools being able to be capped to a controllable and easily manageable extent.

Another particularly preferred embodiment of the method, in particular for producing a gland, can additionally intend that the second section of the blind hole is realized in such a manner in the scope of the subsequent method step that a bottom of the, in particular second section of the, blind hole is formed in the axial direction in an area of maximum widening. In other words, this means that it can be advantageously envisioned that once the subsequent method step has been executed, the bottom of the blind hole has been formed in the axial direction in an area of the shaft which radially abuts against a corresponding tool or tool part upon completion of the subsequent method step. This also means that forming the blind hole leads to a kind of reversal of the flow direction of the material during cold extrusion, at least when indirectly considering the material displacement. For while the blind hole is formed in the axial direction from the screw head toward the shaft or the end side or end face and indirectly causes the shaft to be widened radially in the area of the end face or the end side, material is at least indirectly simultaneously displaced as well, meaning material flows back toward the screw head from the end side or the end face; this leads to a flank or an inclined surface of the shaft being formed, which ultimately forms the desired undercut at least in the crossover between the shaft and the head.

In addition, in a particularly preferred embodiment of the method, which essentially serves for producing a screw element in the form of a nut or a screw nut, it can be intended to form the second section of the blind hole in such a manner in the scope of the subsequent method step that a bottom of the blind hole is formed in the axial direction in the head of the screw element or the screw element blank. The reasons behind the comparatively shallow penetration depth of the blind hole, in particular of the second section of the blind hole, are manifold for the production of a screw element in the form of a nut or a screw nut. On the one hand, the shaft has to be only comparatively marginally widened in the area of the undercut or the turned-down portion for fastening a washer captively or so that it cannot be lost. This applies in particular with regard to the required widening of the shaft for a gland, where an outer thread generally has to be introduced, in particular rolled or milled, in the area of the widened portion. Moreover, the shaft of a screw element in the form of a nut or a screw nut is in general significantly shorter than the shaft of a gland or a comparable screw element so that forming the second section of the blind hole in the area of the head is sufficient to attain a radially widened portion, which is caused by at least indirectly displacing material, including the forming of an undercut or a turned-down portion in the comparatively short shaft.

According to another preferred embodiment of the method, in particular for producing a gland, it can also be envisioned for the shaft, in particular the shaft surface, to be provided with an outer thread by rolling, the thread being formed in such a manner in relation to the widened portion and to the undercut that the thread tapers off in the area of the undercut. This enables attaining an optimal abutment between an underside of the head and an area surrounding a screw opening when a screw is screwed in.

In another advantageous variation of the method, it can also be intended that, in particular in regard to producing a device realized as a nut or a screw nut, the material of the screw element blank between the bottom of the second section and an end face of the shaft facing away from the head is punched or stamped, in particular while retaining the undercut, in the scope of a step for producing a hole.

When producing a hole or when executing the step for producing a hole, it can be intended to punch or stamp a hole having a diameter which corresponds to the diameter of the blind hole, in particular in the first and second section. This in turn means it can be intended that the first section of the blind hole and the second section of the blind hole can have an identical diameter and in particular be round or circular. Producing the hole or the step for producing the hole can be designed in such a manner that a circular hole is punched or stamped between the bottom of the second section of the blind hole and the end face of the shaft facing away from the head. This enables in a particularly advantageous manner providing a screw opening for the screw element realized as a nut or a screw nut. Adjustment to the diameter of the blind hole also bears the advantage that comparatively little material is stamped or punched out of the blank or the screw element blank, resulting in less discarded material.

Another advantageous embodiment of the method, which preferably pertains to the production of a screw element or screw element blank in the form of a nut or a screw nut, can also intend that an inner thread, which preferably extends from the head to an end face of the shaft facing away from the head, is produced in the step for producing a hole, in particular by means of machining. In contrast to an embodiment of the screw element as a screw, in particular as a gland, the outer surface of the shaft, in particular the widened area of the shaft, which forms the undercut or turned-down portion as it continues to cross over to the head, is therefore not machined further. This area of a corresponding screw nut or nut can be inserted into a corresponding deepened portion of a fastening element and aid centering the screw nut there, for example. Similarly, a comparatively long inner thread can be provided across the overall height of the nut, which is made up of the shaft and the head, in an embodiment of the nut or the screw nut having a head and a shaft abutting against it and thus can attain a correspondingly good fastening effect, despite the screw nut only marginally protruding over the fastening element, e.g., with the height of the head, when in the fastened state, in particular when providing a recess or a deepened portion in the fastening element for receiving the shaft. Consequently, a particularly high-quality connection or fastening and a fastening requiring little space is also enabled. Owing to the design according to the invention at hand, which moreover comprises a washer disposed at the crossover between the shaft and the head captively or so that it cannot be lost, a connection or fastening can be additionally established which allows predicting or determining the friction coefficients particularly precisely. The height of the nut protruding over the fastening element is slightly raised by the height of the washer in this case.

Another particularly preferred embodiment of the method, which also preferably focusses on forming a screw element realized as a nut or a screw nut, can additionally intend to form an outer tool engagement portion, in particular an outer spline, in the area of the head in another method step, preferably after the first section of the blind hole has been formed in the head of the screw element blank, the outer tool engagement portion preferably extending across the entire height of the head, at least after a subsequent deburring process.

This achieves that a sufficient torque or sufficient force can be transferred to the nut or screw nut in spite of the comparatively flat head, i.e., in comparison to the overall height of the thread of a corresponding nut, in order to enable a fastening to a fastening element by screwing another screw element into the screw opening. The tool engagement portion, in particular the outer tool engagement portion in the area of the head of the screw element blank, can preferably be produced in the scope of cold working, in particular in the scope of cold extrusion, at least parts of the material of the head being displaced, thus forming a burr encircling the head in the circumferential direction. The burr thus realized can be burred in the scope of another method step. The process of burring can take place, for example, in the same method step as the forming of the second section of the blind hole and consequently in conjunction with the forming of the undercut or the turned-down portion.

As for the screw element blank, in particular produced according to a method according to one of the previously described variations of the method, the object described above is attained by a screw element blank which comprises a head and a cylindrical shaft formed on the head, a blind hole extending toward the shaft starting from the head and having at least one first section, in particular having a polygonal cross section, preferably for receiving a screw tool or having a round cross section as a precursor of a screw opening, and the shaft comprising an undercut at the crossover between the screw head and the shaft, by the blind hole comprising a second section bordering on the first section, the second section having a preferably at least partially continuous cross section which is in particular smaller in size than or identical in size to the first cross section, the undercut being formed by a widened portion formed on part of the shaft formed by at least indirectly displacing material from at least the second section of the blind hole at the crossover between the shaft and the head.

Consequently, screw element blanks are produced using the cold extrusion method as intended by the invention, which on the one hand are subject to no or barely any limitations regarding the embodiment of the end face or the end side of the shaft and moreover produce a particularly high imperviousness between the shaft and the head in conjunction with the undercut and an advantageous securing effect against losing a washer. In turn, this means that especially no deepening, recessing or forming of a blind hole is any longer required in the area of the end face or end side of the shaft in order to form the undercut between the screw head and shaft in the scope of the cold extrusion and consequently without additional machining.

Since the screw element blanks according to the invention to the furthest extent yield the same advantages and advantageous effects regarding the corresponding methods and method steps, reference is made to the corresponding method measures or method steps to supplement the following description for the description of the screw element blanks according to the invention and the advantageous embodiments.

According to an advantageous first embodiment of the screw element blank, it can be intended that the shaft has a widened portion at least in an area opposite the screw head. The widened portion can thus represent the basis for forming the undercut without machining the shaft and/or the head. It is particularly advantageous if the widened portion is not formed or attained by displacing or deforming material in the area of the end face or the end side of the shaft but instead by displacing and/or deforming material in the area of the second section of the blind hole.

According to another particularly advantageous embodiment of the screw element blank, it can be envisioned that a flat end face of the shaft facing away from the screw head or an end face of the shaft equipped with protrusions axially extending away from the end face is formed. Consequently, a particular demand of the corresponding users is met, in particular in regard to glands or gland blanks, who require a flat end face or an end face having a corresponding protrusion for their respective uses of the glands; according to the invention, no additional machining step is required in this instance for forming the undercut between the shaft and the head and the customers' demand can be fulfilled accordingly at minimal production costs.

Furthermore, it can be intended particularly preferably that the screw element blank has an annular sealing surface on an underside of the head facing the shaft for being abutted against an abutment surface of a receiving body, thus forming a coaxial annular groove, which is limited radially outward by a circumferential annular groove. This further improves the imperviousness for a screw element realized as a gland.

Moreover, a preferred embodiment of the screw element blank envisions a maximum widening of the shaft, in particular a maximum widening of the shaft with respect to a diameter not widened in the scope of the subsequent method, is 2% to 9%, in particular 5% to 7%. In this context, it can be preferred for the not widened or original shaft diameter to be measured or determined at the crossover between the screw head and the screw. This enables advantageously attaining on the one hand that the widening is great enough to form the undercut, even when a thread is introduced, in particular rolled or milled, into the widened area of the shaft at a certain tolerance. When the widening is comparatively slight, for example ranging from 2% to 3%, the securing effect for a washer can be advantageously obtained by the widening and the resulting undercut for forming a screw nut.

Another particularly preferred embodiment of the screw element blank can intend that a bottom, in particular of the second section, of the blind hole extends up to 80%, preferably up to 75%, particularly preferably up to 70%, more preferably up to 45%, of the overall height of the blank or the finished screw element starting from the upper side of the head. With regard to the definition of the overall height, reference is made to the explications above. Such a design of the second section of the blind hole, in particular of the bottom of the second section of the blind hole, on the one hand bears the advantage that the screw element blank can be produced with comparatively little material. At the same time, the design of the bottom of the second section of the blind hole also enables a sufficient widening of the shaft at the end opposite the head and a corresponding tapering of the shaft toward the crossover between the shaft and the head, in particular for forming the undercut.

According to another embodiment of the screw element blank, it can be intended for a bottom, in particular of the second section, of the blind hole to extend or be disposed in the axial direction in an area of maximum widening. This not only yields in a particularly preferable manner the radial widening of the shaft in the corresponding section, at least by indirectly displacing material, but simultaneously causes an even flank to be formed as the crossover between a widened and a not widened area of the diameter of the shaft so that on the one hand it is possible for an introduced or milled or rolled thread to taper off in this area and on the other hand a crossover is produced between the thread area and the undercut area or the undercut.

According to another particularly preferred embodiment of the screw element blank, it can be intended that the blind hole has a third section which borders the second section and which is formed concentrically to the first and/or second section of the blind hole and preferably forms a cone segment, which tapers toward the shaft and ends in a flat bottom of the blind hole parallel to the upper side. The third section of the blind hole can preferably be formed in conjunction with the second section of the blind hole in the subsequent method step. The third section of the blind hole on the one hand leads to optimizing or minimizing the amount of required material. On the other hand, the third section of the blind hole enables a particularly precise and even forming of a crossover between a widened section of the shaft and a not widened section of the shaft or a section of the shaft forming the undercut.

With regard to the screw element according to the invention, in particular a gland according to the invention, the object mentioned above is attained by the screw element, in particular the gland, being made from a screw element blank of the make mentioned above. This means that essentially the undercut or turned-down portion which is provided in the screw element blank in the crossover between the shaft and the head, but which was produced without or at least without any noticeable deformation of the end face of the shaft facing away from the head, is retained and apart from this essentially known processing steps are used to ensure that the screw blank or the screw element blank is processed to form a screw, in particular a gland.

According to a first advantageous embodiment of the screw element according to the invention, in particular of the gland according to the invention, it can be envisioned that the shaft, in particular the shaft surface, comprises a thread, in particular an outer thread, the thread being formed in such a manner relative to the widened portion and the undercut of the shaft that the thread completely tapers off in the area of the undercut. This enables a particularly good imperviousness of the gland since the head can abut particularly easily and precisely at a corresponding opening or recess which is closed by the gland.

With regard to a screw element, in particular a nut or a screw nut, the object mentioned above is attained by the screw element, in particular the nut or screw nut, being formed from a screw element blank described above. This means that an undercut or a turned-down portion is formed between the shaft and the head or in an area of the shaft bordering the head as intended by the invention in terms of the nut or the screw nut without the end of the shaft facing away from the head or the end side of the shaft facing away from the head being substantially deformed for its forming.

According to another advantageous embodiment of the screw element, it can also be intended to provide a screw opening which is formed by a recess in the shaft, which widens the blind hole of the screw element blank to an axially continuous opening. In this context, the screw opening of the screw elements according to the invention, in particular the nuts or screw nuts according to the invention, is formed, in particular stamped or punched, after forming the undercut or the turned-down portion. It is particularly preferable if the screw hole or the screw opening, along with the blind hole, is punched from the side of the head. This means that the screw opening is punched toward the end of the shaft facing away from the head. This can ensure that the punching or stamping can be carried out essentially without any impact on the shaft and consequently without any impact on the undercut or the turned-down portion in the area of the shaft.

Another particularly advantageous embodiment of the screw element, in particular the nut, can also envision the screw opening comprising an internal thread, which preferably extends across the entire screw opening.

Furthermore, it can be advantageously intended for the screw element according to the invention, in particular the nut according to the invention, to have a washer, which is disposed in the area of the shaft captively or in a manner so that it cannot be lost, for which purpose the inner diameter of the washer is smaller at least in sections than the outer diameter of the widened area of the shaft and preferably is slightly larger than the outer diameter of the undercut or the area of the shaft in which the undercut is formed. This ensures that the washer does not have to be handled separately when mounting or fastening the nut. At the same time, it is ensured that the friction coefficients of the connection or the fastening produced by means of the nut can be precisely predicted or determined owing to the washer.

Via the preferred embodiment of a slightly larger inner diameter of the washer with respect to the outer diameter of the undercut or the turned-down portion, it can also be attained that the washer is disposed on or fastened to the nut captively or in a manner so that it cannot be lost, though at the same time a slight rotation and/or inclination of the washer with respect to the shaft or the nut can be carried out, which in turn simplifies mounting the nut.

### BRIEF DESCRIPTION OF THE DRAWINGS

Further advantages, features and details of the invention can be derived from the following description of preferred exemplary embodiments and from the drawings.

FIGS. 1a, 1b show a first method step preceding the method of the invention for producing a screw element blank and a blank emerging from the method step;

FIGS. 2a, 2b show a first method step for producing a screw element according to the invention or a screw element blank according to the invention and a corresponding screw element blank;

FIGS. 3a-3c show a subsequent method step for producing a screw element according to the invention or a screw element blank according to the invention and a corresponding screw element blank;

FIG. 4 shows a perspective view and a perspective cut view of a stage process which aims at producing a screw element blank according to the invention and comprises the method according to the invention;

FIG. 5 shows a stage process which aims at producing a screw element blank according to the invention and comprises the method according to the invention in a lateral cut view and in a partial top view on the corresponding stages of the blanks;

FIG. 6 shows a schematic view of a washer for use with a screw element according to the invention or a screw element blank according to the invention.

### DETAILED DESCRIPTION

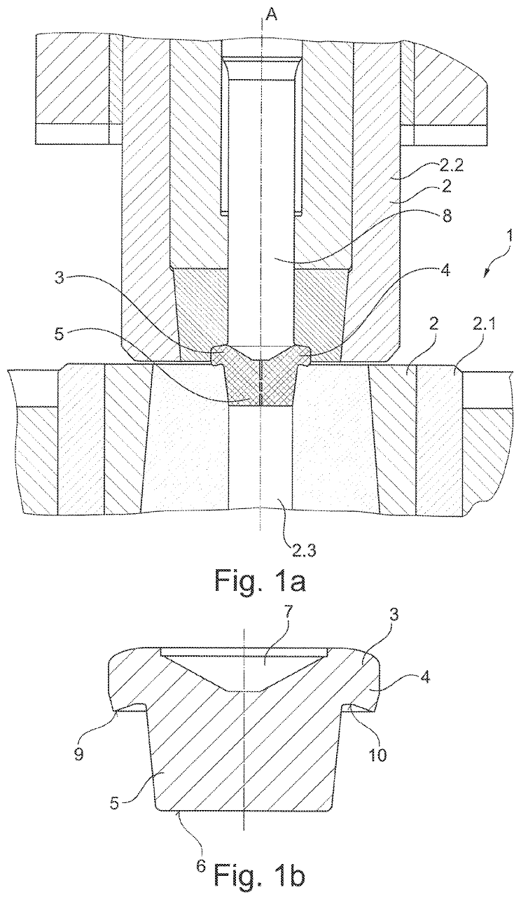

In FIGS. 1 to 3, an exemplary embodiment of the invention is described, which refers to a screw element designed as a gland and the corresponding production. Individual features, method steps or properties can, however, also be used for the following description of a screw element or a blank for a screw nut.

FIG. 1a shows a two-piece tool 1 and a blank 3 of a gland located in tool 1, in particular between the two tool pieces 2. FIG. 1b shows blank 3 of a gland as obtained by carrying out the method step which is produced within the scope of processing using tool 1 of the method step of FIG. 1a. The processing according to FIG. 1a and the shape of blank 3 according to FIG. 1b precede the method according to the invention or can precede the method according to the invention. In particular, however, the shape of blank 3 and the embodiment of tool parts 2 of tool 1 display the hitherto known limitations or boundaries of cold extrusion. The two tool parts 2 form a receiving tool part 2.1 and a deforming tool part 2.2 on the one hand, receiving tool part 2.1 having a constriction or tapering extending away from screw head 4 in axial direction A. This ensures that shaft 5, which borders head 4, can be removed or exited from receiving tool part 2.1 in particular via a pushing or thrusting movement using a plunger 2.3 in axial direction A after the processing step or the method step as illustrated in FIG. 1a has been executed.

In the method step or in the production stage of the gland or of gland blank 3, as illustrated in FIG. 1a, it is accordingly of no consequence that shaft 5 of blank 3 completely abuts against the radial walls of receiving tool part 2.1 after deforming tool part 2.2 has been applied. However, as in particular FIG. 1a illustrates, a flank or tapering of shaft 5 oriented differently or negatively in axial direction A with respect to the longitudinal axis, i.e., a tapering toward screw head 4, would not be possible at least for a one-piece receiving tool part 2.1, since an exit or ejection via plunger 2.3 would fail because the end side or end face 6 of blank 3 has a larger diameter with respect to the crossover between shaft 5 and head 4 of blank 3, thus making an ejection in axial direction A impossible at least without reversing the tapering.

Besides head 4 and shaft 5 bordering head 4, which is still tapered in the example of FIG. 1b from the crossover between head 4 and shaft 5 to the end side or end face 6 of shaft 5 in the axial direction, corresponding blank 3, as illustrated in FIG. 1b, consequently also comprises a blind hole 7 or a preliminary form of a blind hole 7. Blind hole 7 is deformed in blank 3 or impressed in blank 3 by a stamp 8 comprised by deforming tool part 2.2, the preliminary form of blind hole 7 leading to shaft 5 being circumferentially or radially pressed against and thereby molded to tool 1, in particular receiving tool 2.2, material being displaced in the process.

In addition, the abutments in the area of head or screw head 4 are already present in blank 3 of FIG. 1b in order to form an annular sealing surface 10 on an underside 9 of head or screw head 4 facing shaft 5 for abutting against an abutment surface of a receiving body of the gland, a coaxial annular groove being formed in the process.

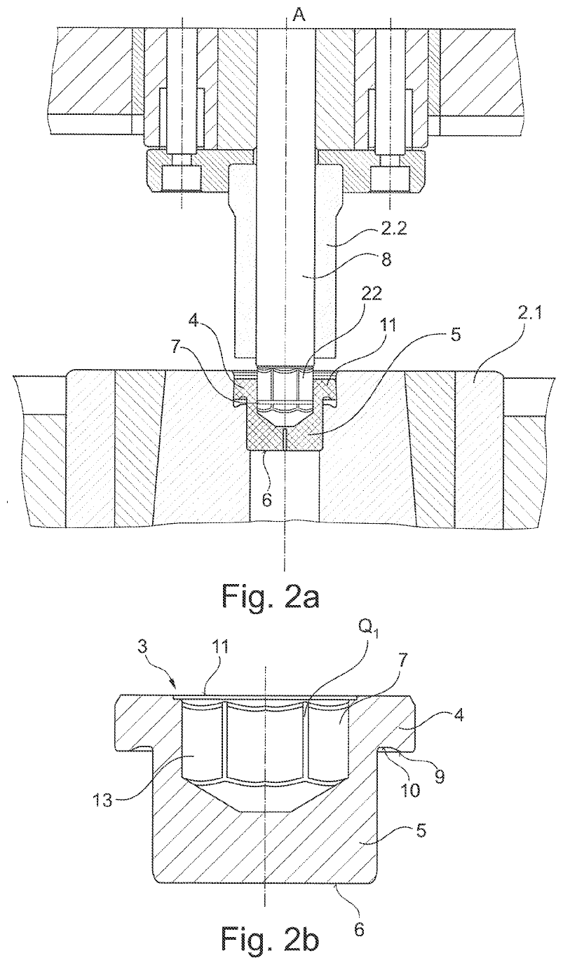

Following the processing station or the method step, as shown in the illustration of FIG. 1a, a processing station and/or a method step can be reached or executed as illustrated in FIG. 2a, for example after blank 3 has been ejected via plunger 2.3. In this step or at this station, a blind hole 7 is also formed from an upper side 11 of head or screw head 4 facing away from shaft 5 using a corresponding two-piece tool 1 in an ultimately known manner, blind hole 7 extending toward shaft 5 and comprising at least the first section illustrated in the processing station and/or in the method step of FIG. 2a, the first section preferably having a polygonal cross section, preferably for receiving a screw tool for screwing in the gland. For this purpose, deforming tool 2.2 also comprises or again comprises a stamp 8, which is imprinted in screw head 4 and subjacent shaft 5 from the side of upper side 11 of head or screw head 4, leading to the cross section of end section 12 of stamp 8 being produced as the first cross section or as a cross section of a first section 13 of bling hole 7. Moreover, receiving tool 2.1, which is of a one-piece design with the exception of plunger 2.3, has surfaces extending parallel to axial direction A so that shaft 5 of blank 3 is formed to a cylindrical, in particular a circular-cylindrical, shape starting from the tapered shape, as illustrated in FIG. 1b, by producing first section 13 of blind hole 7.

In FIG. 2b, corresponding blank 3 is illustrated in an enlarged view. On the one hand, a first section 13 of a blind hole 7 can be discerned, which extends from upper side 11 of screw head 4 toward shaft 5. In addition, cross section Q1 of first section 13 of blind hole 7 is discernable in FIG. 1b, which is preferably designed to receive a screw tool. In addition, it can be discerned in the illustration of blank 3 according to FIG. 2b that shaft 5 has taken up an essentially cylindrical outer contour, which is ensured by at least indirectly displacing material from the area of first section 13 of blind hole 7 and by a corresponding design of receiving tool 2.1. The cylindrical shape or outer contour of shaft 5 of screw blank 3 enables ejecting again screw blank 3 using a plunger 2.3 allocated to receiving tool part 2.1 following the processing or the processing step of the illustration of FIG. 2a, in particular without other parts of receiving tool part 2.1 having to be changed, in particular having to be disassembled into several pieces or subgroups.

Sealing surface 10 already supplied or preformed in blank 3 of FIG. 1b and disposed on underside 9 of head or screw head 4 is also retained or further defined by the processing station of FIG. 2a.

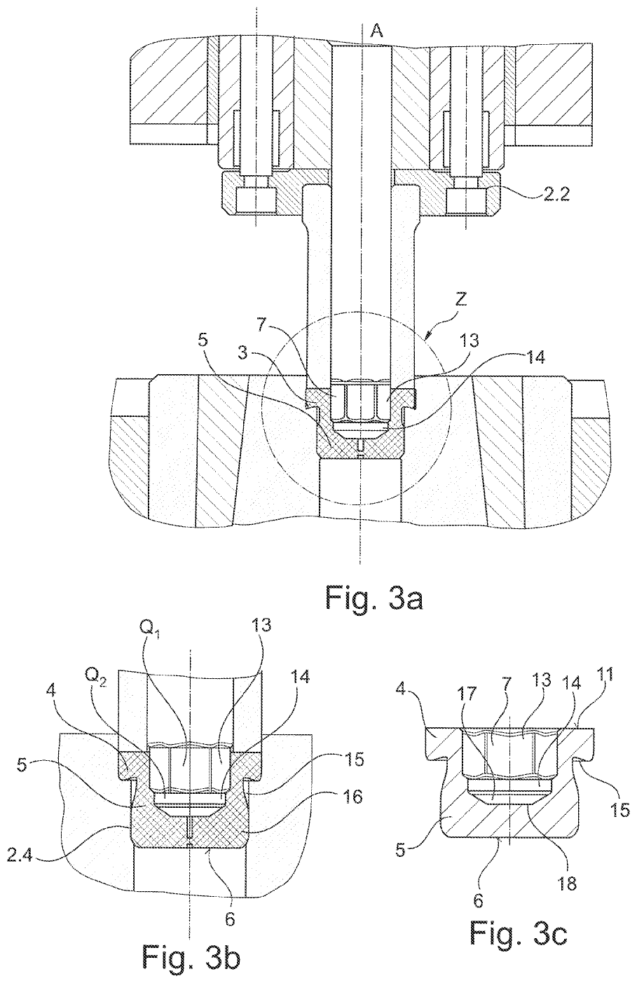

FIGS. 3a and 3b show a processing situation or a processing station of the method according to the invention where the subsequent method step according to the invention is executed. Accordingly, FIG. 3c shows a blank of a gland or a gland itself which represents the result of the method according to the invention, i.e., a blank 3 according to the invention or a gland according to the invention. In the method step of FIG. 3a, again using a deforming tool part 2.2, blind hole 7 already formed in screw blank 3 is deepened by a second section 14, which borders first section 13, which is also attained by a correspondingly formed stamp 8 of deforming tool part 2.2. Second section 14 of blind hole 7 has a second cross section Q2, which is smaller with respect to first cross section Q1, i.e., to cross section Q1 of first section 13 of blind hole 7.

At least by indirectly displacing material from at least second section 14 of blind hole 7, an undercut 15, which is disposed at the crossover between shaft 5 and head 4 of blank 3, is further formed in shaft 5 of the gland or blank 3 of the gland. Undercut 15 aids attaining an improved imperviousness of the gland in particular without machining. The illustration of FIG. 3a indicates and the enlarged illustration of section Z of FIG. 3a in FIG. 3b clearly depicts that shaft 5 is widened at least in an area 16 opposite the screw head at least by indirectly displacing material from second section 14 of blind hole 7 within the scope of forming or producing second section 14 of blind hole 7. In addition, it is discernable in particular in FIG. 3b that a part of the widened section of shaft 5 abuts against radial deforming tool part 2.4 of receiving tool part 2.2, i.e., in particular in widened area 16, after the subsequent method step has been terminated, which is depicted in FIGS. 3a and 3b; in contrast, the part of shaft 5 forming undercut 15 has an increasingly larger distance in axial direction A toward head or screw head 4 with respect to radial deforming tool part 2.4. This distance, which is formed between blank 3 and radial deforming tool part 2.4, becomes increasingly larger toward head or screw head 4 and can be discerned particularly clearly in FIG. 3b, forms the deviation according to the invention from the hitherto known cold extrusion methods, where a corresponding complete abutment with a radial deforming tool part 2.4 had been presumed by necessity.

On the one hand, this enables that a widened portion in area 16 and consequently undercut 15 can be produced; simultaneously, however, end side or end face 6 can have a flat or otherwise arbitrarily formed, in particular a protrusion that protrudes away from head or screw head 4, while blank 3, in particular after second section 14 of blind hole 7 has been formed or impressed, can still be removed, in particular ejected, from receiving tool part 2.2, in particular from radial deforming tool part 2.4, by a plunger 2.3 without affecting undercut 15 or widened area 16 in the process nor receiving tool part 2.2, in particular radial deforming tool part 2.4, having to be opened or split in radial direction A.

In the subsequent method step, as exemplarily illustrated in FIGS. 3a and 3b, a gland or a gland blank 3 having a flat end face or end side 6 is accordingly produced, which additionally has a widened portion of shaft 6 giving grounds to undercut 15, does in particular not require machining blank 3 for forming undercut 15 and overall allows producing blank 3 by means of the cold extrusion method. In the example of FIG. 3c, blind hole 7 also comprises an advantageous third section 17, which abuts against second section 14 or borders second section 14, which is concentric to first and/or second section 14 of blind hole 7 and forms a cone segment, which tapers in direction A of shaft 5 and in particular ends in a flat bottom 18 of blind hole 7, which extends parallel to upper side 11 of head or screw head 4.

Preferably, the widening of shaft 5, in particular in area 16 of the maximum widening, can be 3% to 9%, preferably 5% to 7%, of the not widened diameter of shaft 5 in order to particularly advantageously introduce, in particular cut, a corresponding thread in shaft 5, thus mostly completing the process of turning blank 3 into a gland. The not widened diameter of shaft 5 or the shaft diameter can, for example, be determined based on the shaft diameter of FIG. 2b or the shaft diameter of FIG. 3c at the crossover between shaft 5 and head or screw head 4. As can be discerned in the illustration of FIG. 3c, bottom 18 of blind hole 7 extends up to approximately 75% of the overall height of the screw or screw blank 3, the overall height being determined between end face or end side 6 on the one hand and upper side 11 of head or screw head 4 on the other hand. In addition, bottom 18 of blind hole 7 is formed or disposed in such a manner that bottom 18 is formed in an area 16 of maximum radial widening in axial direction A. This advantageously causes forming the flank or tapering, which in turn causes blind hole 5 to be formed or at least prompts it.

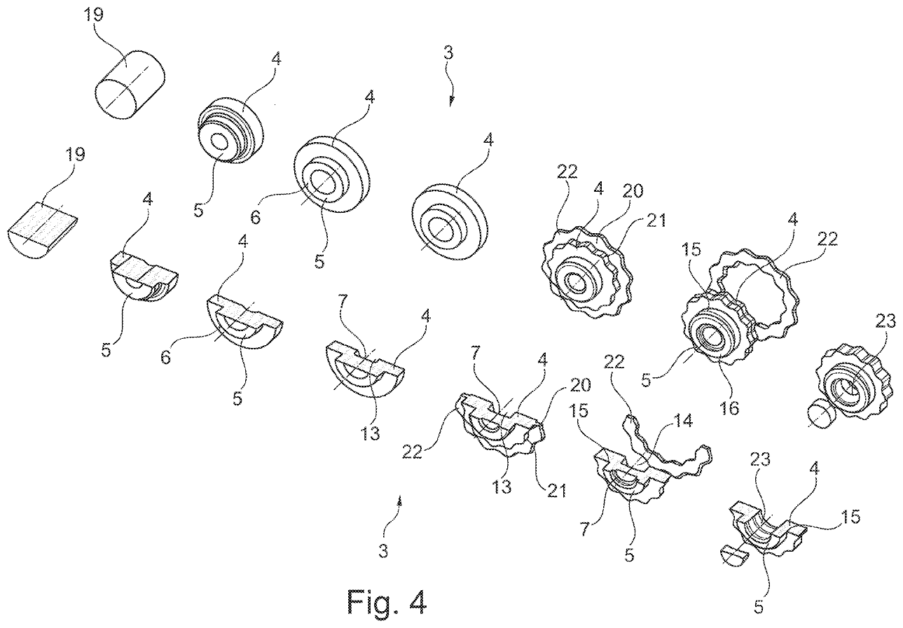

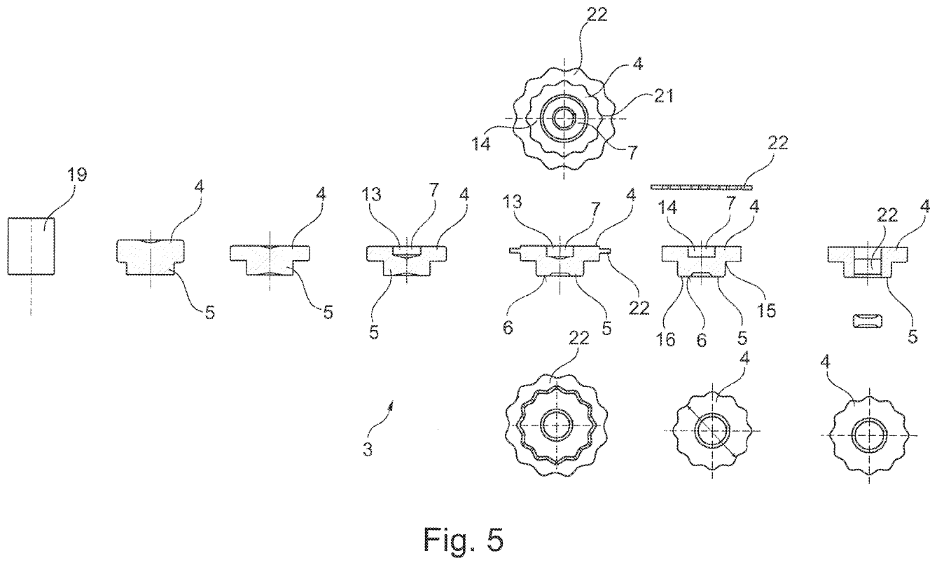

In FIGS. 4 and 5, an exemplary embodiment of the invention is described which refers to a screw element designed as a screw nut or nut and to the corresponding production or the corresponding production method. Individual features, method steps or properties can, however, also be used for the previously described production of a screw element or a screw element blank for a gland. The individual stages of the screw element blank are illustrated in different views in both FIGS. 4 and 5. Concerning the tools used for the forming, reference is made to the illustrations of FIGS. 1 to 3 regarding the principles. This means that the blank is formed according to FIGS. 4 and 5, at least in as far as it is illustrated, using method steps of cold working, in particular cold extrusion.

In the illustration of FIG. 4, the stages of the screw element blank during the production of a blank of a nut or a screw nut are illustrated in the sequence of the processing or deforming steps from left to right, each method step or stage being shown in a perspective view and along a perspective cutting plane. In the first three stages, a cylindrical base body 19 is formed in such a manner that it has a head 4 and a shaft 5 bordering on head 4. It can be discerned that shaft 5 does not have a flat or smooth surface on its end side 6 facing away from the head but rather a slight contour, which essentially serves for centering the blank within the scope of the correspondingly following processing or method steps.

In the fourth illustrated stage or method step, a blind hole 7 or rather a first section 13 of a blind hole 7 is produced in the area of head 4 of the blank.

In the following method step, on the one hand, first section 13 of blind hole 7 is further formed or deepened in the area of head 4, while simultaneously an outer tool engagement portion 21 is formed on outer circumference 20 of shaft 4, a burr 22 being produced in the area of head 4 of the screw element blank when forming outer tool engagement portion 21. In the following method step or stage of screw element blank 3, burr 22 is on the one hand deburred, while simultaneously a second section 14 of blind hole 7 is formed in such a manner that an area 16 facing away from or being opposite head 4 is created in the area of shaft 5, area 16 being radially widened by at least indirectly displacing material from second section 14 of blind hole 7 so that an undercut 15 is formed at the same time in an area of shaft 5 bordering on head 4. When observing end side 6 of shaft 5 facing away from the head, it becomes obvious that the profile of end side 6 is marginally changed. This change in the profile, however, is not sufficient to form undercut or turned-down portion 15. Equally, the change in the profile of end face 6 of shaft 5 is not significantly involved in at least indirectly displacing material which leads to forming undercut 15. The method according to the invention accordingly is to include methods where end side 6 of the shaft facing away from the head does not remain entirely unchanged, but is rather subject to smaller or minimal changes, which at the same time, however, do not have any or hardly any noticeable influence on forming the undercut. In turn, this means the undercut is produced almost exclusively by material being indirectly displaced within the scope of producing or forming the second section of blind hole 7 from the direction of head 4 of screw element blank 3 as intended by the method according to the invention.

In a last stage or method state of the method according to the invention for producing a screw element blank, FIG. 4 shows a step for producing a hole, where a screw opening 23 is formed from blind hole 7 by stamping or punching, screw opening 23 being produced in such a manner that undercut 15 remains largely untouched in the crossover area between shaft 5 and head 4. For this purpose, the stamping or punching is carried out from the side of head 4 toward shaft 5, for example. In order to produce a nut or a screw nut according to the invention from screw element blank 3 as intended by the last stage or method step of FIG. 4, it can be further envisioned that an inner thread is formed, in particular cut, in the area of screw opening 23. It can also be envisioned that a washer is disposed in the area of undercut 15 captively or so that it cannot be lost.

FIG. 5 shows the stage process of FIG. 4 in lateral sectional illustrations and at least partially in top views on screw element blank 3. The lateral sectional illustrations show clearly that the widening of lower area 16 of shaft 5 or area 16 of shaft 5 facing away from head 4 can turn out to be comparatively low and the prominence of undercut 15 turns out to be accordingly low as well. This is owed to the fact that undercut 15 merely serves for fastening or disposing a washer captively or in such a manner that it is secured against loss.

Furthermore, the sectional illustration of the side views of FIG. 5 shows that second section 14 of blind hole 7 or entire blind hole 7, which is produced by at least indirectly displacing material for forming the undercut, is almost entirely disposed in the area of head 4. Contrary to the exemplary embodiment of the gland according to FIGS. 1 to 3, this means that blind hole 7 does not or at least not significantly enter the area of shaft 5, let alone an area of maximum widening of the shaft. Forming second section 14 in the area of head 4 shown in FIG. 5 is already sufficient, however, for producing undercut 15 via correspondingly indirectly displacing material and widening shaft 5 in area 16.

The lateral sectional illustrations of FIG. 5, in particular in comparison to the fifth and sixth stages or method steps, show that the additional deforming of end face 6 of shaft 5 does not add or only negligently adds anything to forming undercut 15. The deformation in the area of end face 6 indeed serves for centering blank 3 for the subsequent processing or deforming steps and for preparing for forming the screw hole or screw opening 23, which is produced by a corresponding punching or stamping according to the illustration of the last stage of FIG. 5.

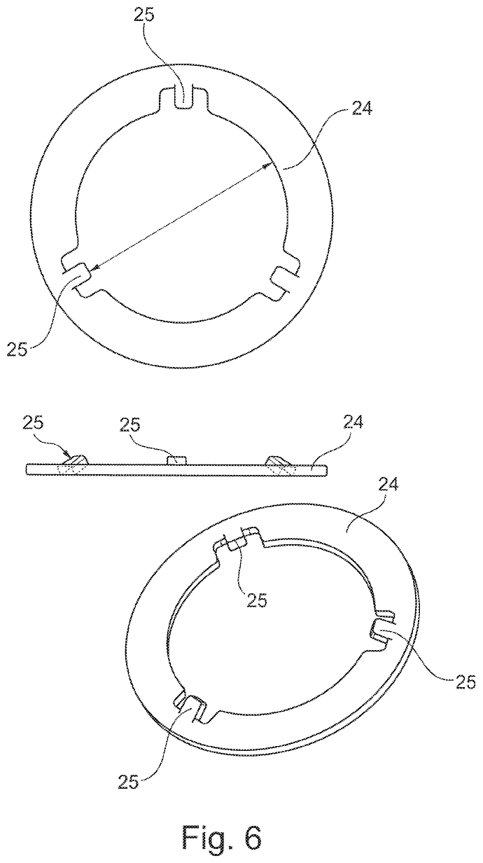

FIG. 6 shows different views of a washer 24 or a sliding disk, which in conjunction with a screw element blank 3 according to FIGS. 4 and 5 can be assembled to a nut, where washer 24 is disposed in the area of shaft 5 so that it cannot be lost. In the lateral view of washer 24, it can be discerned that dogs 25, which are oriented radially inward, are formed in the inner circumference and are partially set back, are bent upward or out of the washer plane. This deformation of the dogs or the deformed state of the dogs achieves that a uniform inner diameter is also attained in the area of dogs 25 or even an inner diameter which is slightly larger than the other inner diameter of the washer is attained in the area of dogs 25. This can be discerned in the top view on washer 24 of FIG. 6, for example.

In the deformed state of dogs 25, the inner diameter, however, is chosen such at each location that it is at least slightly larger than the widened section of a corresponding screw element or blank. Consequently, the washer can be slid across this section of the shaft and be moved to the head or into the area of the undercut. As soon as the washer is disposed in the area of the undercut, dogs 25 can be deformed, in particular returned, into or back into the plane of the washer by a deforming tool, whereby they realize a reduced inner diameter in the area of dogs 25.

This leads to the inner diameter of washer 24 being smaller at least in sections owing to returned dogs 25 than the outer diameter of widened area 16 of shaft 5. This ensures washer 24 is disposed so that it cannot be lost at screw element 3, in particular the nut.

### LIST OF REFERENCE NUMERALS

1 tool
2 tool parts
2.1 receiving tool part
2.2 receiving tool part
2.3 plunger
2.4 deforming tool part, radial
3 blank
4 head/screw head
5 shaft
6 end side
7 blind hole
8 stamp
9 underside
10 sealing surface
11 upper surface
12 end section
13 first section
14 second section
15 undercut
16 area
17 third section
18 bottom
20 outer circumference
21 outer tool engagement portion
22 burr
23 screw opening
24 washer
25 dog
A axial direction
Q1 first cross section
Q2 second cross section

1. A method for producing a screw element or a screw element blank (3), the method comprising a step of producing a blank (3) having a cylindrical shaft (5) formed on a head (4), and a blind hole (7) being formed in the blank (3) from an upper side (11) of the head (4) facing away from the shaft (5), the blind hole (7) extending toward the shaft (5) and forming at least one first section (13),
wherein
the blind hole (7) is deepened, thus forming at least one second section (14), which borders the first section (13), in a subsequent method step, the second section (14) forming an at least partially continuous cross section (Q2) which is smaller in size than the first cross section (Q1), the shaft (5) being widened in sections, thus forming an undercut (15) at the crossover between the shaft (5) and the head (4) by at least indirectly displacing material from at least the second section (14) of the blind hole (7), in the subsequent method step.

2. The method according to claim 1, wherein the shaft (5) is widened at least in an area (16) opposite the head (4).

3. The method according to claim 1, wherein a part of the widened section (16) abuts against a radial deforming tool or tool part (2.4) after the subsequent method step has been executed, whereas the part of the shaft (5) forming the undercut (15) forms a distance axially increasing toward the head (4) with respect to the radial deforming tool or tool part.

4. The method according to claim 1, wherein a flat end face of the shaft (5) facing away from the head (4) or an end face of the shaft (5) which is equipped with a protrusion axially extending away from the end face remains or is formed in the scope of the subsequent method step.

5. The method according to claim 1, wherein an annular sealing surface (20) is formed on an underside (9) of the head (4) facing the shaft (5) for being abutted against an abutment surface of a receiving body, thus forming a coaxial annular groove, which is bordered radially outward by an encircling annular wall.

6. The method according to claim 1, wherein a washer is disposed in the area of the undercut (15), the washer being deformed such that the inner diameter is slightly larger than the outer diameter of the undercut and is smaller than the outer diameter of the widened section (16) of the shaft (5) after having been deformed.

7. The method according to claim 1, wherein a maximum widening of 2% to 9% with respect to the shaft diameter is produced in the subsequent method step.

8. The method according to claim 1, wherein the blind hole (7) is realized in such a manner that a bottom (18) of the second section (14) of the, blind hole (7) extends up to 80% of the overall height of the screw element starting from the upper side (11) of the head (4) after the subsequent method step has been executed.

9. The method according to claim 1, wherein the first section (13) of the blind hole (7) is realized in such a manner that a bottom of the first section (13) of the blind hole (7) extends up to 70%, of the overall height of the screw element starting from the upper side (11) of the head (4).

10. The method according to claim 1, wherein the first section of the blind hole is formed in two or more partial steps, 700 of the overall depth of the blind hole being produced in a first partial step.

11. The method according to claim 1, wherein the second section (14) of the blind hole is produced in such a manner in the scope of the subsequent method step that a bottom (18) of the, second section (14) of the blind hole (7) is formed in the axial direction (A) in an area (16) of maximum radial widening.

12. The method according to claim 1, wherein a bottom (18) of the second section (14) of the blind hole (7) is formed in the axial direction (A) in the head (4).

13. The method according to claim 1, wherein the shaft (5) is equipped with a thread in particular by means of non-machining methods, the thread being realized in such a manner relative to the widened portion and to the undercut (15) that the thread completely tapers off in the area of the undercut (15).

14. The method according to claim 1, wherein the material between the bottom of the second section (14) and an end face of the shaft (5) facing away from the head (4) is punched or stamped while maintaining the undercut, in a step for producing a hole.

15. The method according to claim 14, wherein an internal thread, which extends from the head (4) to an end face of the shaft (5) facing away from the head (4), is produced by machining in the hole produced in the step for producing the hole.

16. The method according to claim 1, wherein an outer tool engagement portion is formed in a method step after having formed the first section of the blind hole in the area of the head (4), the outer tool engagement portion extending across the entire height of the head (4) at least after a subsequent deburring process.

17. A screw element blank produced according to claim 1 a method according to, the screw element blank comprising a head (4) and a cylindrical shaft (5) formed on the head (4), a blind hole (7) extending toward the shaft (5) starting from the head (4) and having at least one first section (13) having a polygonal cross section (Q1) for receiving a screw tool or having a round cross section (Q2) as a precursor of a screw opening (23), and the shaft (5) comprising an undercut (15) at the crossover to the head (4), wherein
the blind hole (7) comprises a second section (14) bordering on the first section (13), the second section (14) having an at least partially continuous cross section (Q2) which is smaller in size than the first cross section (Q1), the undercut (15) being formed by a widened portion formed on part of the shaft (5) by at least indirectly displacing material from at least the second section (14) of the blind hole (7) at the crossover between the shaft (5) and the screw head (4).

18. The screw element blank according to claim 17, wherein the shaft (5) has the widened portion at least in an area (16) opposite the screw head (4).

19. The screw element blank according to claim 17, further comprising a flat end face of the shaft (5) facing away from the head (4) or an end face of the shaft (5) which is equipped with a protrusion axially extending away from the end face.

20. The screw element blank according to claim 17, further comprising an annular sealing surface (10), which is formed on an underside (9) of the head (4) facing the shaft (5), for being abutted against an abutment surface of a receiving body, thus forming a coaxial annular groove, which is bordered radially outward by an encircling annular wall.

21. The screw element blank according to claim 17, wherein a maximum widening is 2% to 90% with respect to the shaft diameter at the crossover to the head (4).

22. The screw element blank according to claim 17, wherein a bottom (18) of the second section (14) of the blind hole (7) extends up to 80% of the overall height of the screw starting from the upper side (11) of the head (4).

23. The screw element blank according to claim 17, wherein a bottom (18) of the second section (14) of the blind hole (7) extends in the axial direction (A) in an area of maximum radial widening.

24. The screw element blank according to claim 17, wherein the blind hole (7) comprises a third section (17), which borders the second section (14), the third section (17) being concentric to the first and/or second section (13, 14) and forming a cone segment, which tapers in the direction (A) of the shaft (5) and ends in in a flat bottom (18) of the blind hole (7) extending parallel to the upper side (11).

25. A screw element, comprising a gland produced from a screw element blank according to claim 17.

26. The screw element according to claim 25, wherein the shaft (5) has a thread realized in such a manner relative to the widened portion and to the undercut (15) that the thread completely tapers off in the area of the undercut (15).

27. A screw element, comprising a nut produced from a screw element blank according to claim 17.

28. The screw element according to claim 27, further comprising a screw opening, which is formed in the shaft by a recess widening the blind hole to an axially continuous opening.

29. The screw element according to claim 27, wherein the screw opening comprises an inner thread, which extends across the entire screw opening.

30. The screw element according to claim 27, further comprising a washer, which is captively disposed in the area of the shaft, for which purpose the inner diameter of the washer is smaller at least in sections than the outer diameter of the widened area (16) of the shaft (5) and is slightly larger than the outer diameter of the undercut (15).
